(19) United States
(12) Patent Application Publication
(10) Pub. No.: US 2013/0242932 A1
(43) Pub. Date: Sep. 19, 2013

(54) Secondary Spectrum Use

(71) Applicants: Esa Tapani Tiirola, Kempele (FI); Kari Juhani Hooli, Oulu (FI); Jari Yrjana Hulkkonen, Oulu (FI)

(72) Inventors: Esa Tapani Tiirola, Kempele (FI); Kari Juhani Hooli, Oulu (FI); Jari Yrjana Hulkkonen, Oulu (FI)

(73) Assignee: NOKIA SIEMENS NETWORKS OY, Espoo (FI)

(21) Appl. No.: 13/989,257

(22) PCT Filed: Nov. 24, 2010
(86) PCT No.: PCT/EP2010/068118

§ 371 Date: May 23, 2013

(51) Int. Cl. H04W 16/14

(52) U.S. Cl. CPC H04W 16/14
USPC 370/329

(57) ABSTRACT

The invention relates to apparatuses, methods, computer programs and computer-readable media.

### FIELD

The invention relates to apparatuses, methods, computer programs, computer program products and a computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Recently need for more efficient usage of radio resources has brought out an idea of co-existence or sharing of systems meaning that systems share operational resources, for example spectrum in a given region.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: define at least one primary system communication resource to be protected from secondary system usage, and convey information on the defined at least one primary system communication resource to be protected to network elements involved.

According to an aspect of the present invention, there is provided an apparatus comprising: at least one processor and at least one memory including a computer program code, the at least one memory and the computer program code configured to, with the at least one processor, cause the apparatus at least to: determine a type of resource usage, and modify at least one transmission format based on information on protection needs of primary system communication resources for protecting chosen at least one primary system communication resource from secondary system usage, if the type of resource usage is the secondary system usage.

According to another aspect of the present invention, there is provided a method comprising: defining at least one primary system communication resource to be protected from secondary system usage, and conveying information on the defined at least one primary system communication resource to be protected to network elements involved.

According to another aspect of the present invention, there is provided a method comprising: determining a type of resource usage, and modifying at least one transmission format based on information on protection needs of primary system communication resources for protecting chosen at least one primary system communication resource from secondary system usage, if the type of resource usage is the secondary system usage.

According to yet another aspect of the present invention, there is provided an apparatus comprising: means for defining at least one primary system communication resource to be protected from secondary system usage, an means for conveying information on the defined at least one primary system communication resource to be protected to network elements involved.

According to yet another aspect of the present invention, there is provided an apparatus comprising: means for determining a type of resource usage, and means for modifying at least one transmission format based on information on protection needs of primary system communication resources for protecting chosen at least one primary system communication resource from secondary system usage, if the type of resource usage is the secondary system usage.

According to yet another aspect of the present invention, there is provided computer program embodied on a computer-readable storage medium, the computer program comprising program code for controlling a process to execute a process, the process comprising: defining at least one primary system communication resource to be protected from secondary system usage, and conveying information on the at least one defined primary system communication resource to be protected to network elements involved.

According to yet another aspect of the present invention, there is provided computer program embodied on a computer-readable storage medium, the computer program comprising program code for controlling a process to execute a process, the process comprising: determining a type of resource usage, and modifying at least one transmission formats based on information on protection needs of primary system communication resources for protecting chosen at least one primary system communication resources from secondary system usage, if the type of resource usage is the secondary system usage.

### LIST OF DRAWINGS

Embodiments of the present invention are described below, by way of example only, with reference to the accompanying drawings, in which

FIG. 1 illustrates an example of a system;

FIG. 2 is a flow chart;

FIG. 3 is another flow chart,

FIGS. 4, 5, 6, 7 and 8 illustrate clarifying examples, and

FIG. 9 shows an example of an apparatus.

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly, Such development may require extra changes to an embodiment. Therefore, all words and expressions should be interpreted broadly and they are intended to illustrate, not to restrict, embodiments.

In the following, different embodiments will be described using, as an example of an access architecture to which the embodiments may be applied, a radio access architecture based on long term evolution (LTE) Advanced, LTE-A, that is based on orthogonal frequency multiplexed access (OFDMA) in a downlink and a single-carrier frequency-division multiple access (SC-FDMA) in an uplink, without restricting the embodiments to such an architecture, however.

In an orthogonal frequency division multiplexing (OFDM) system, the available spectrum is divided into multiple orthogonal sub-carriers. In OFDM systems, available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB needs to know channel quality of each user device and/or the preferred precoding matrices (and/or other multiple input-multiple output (MIMO) specific feedback information, such as channel quantization) to schedule transmissions to user devices. Required information is usually signalled to the (e)NodeB.

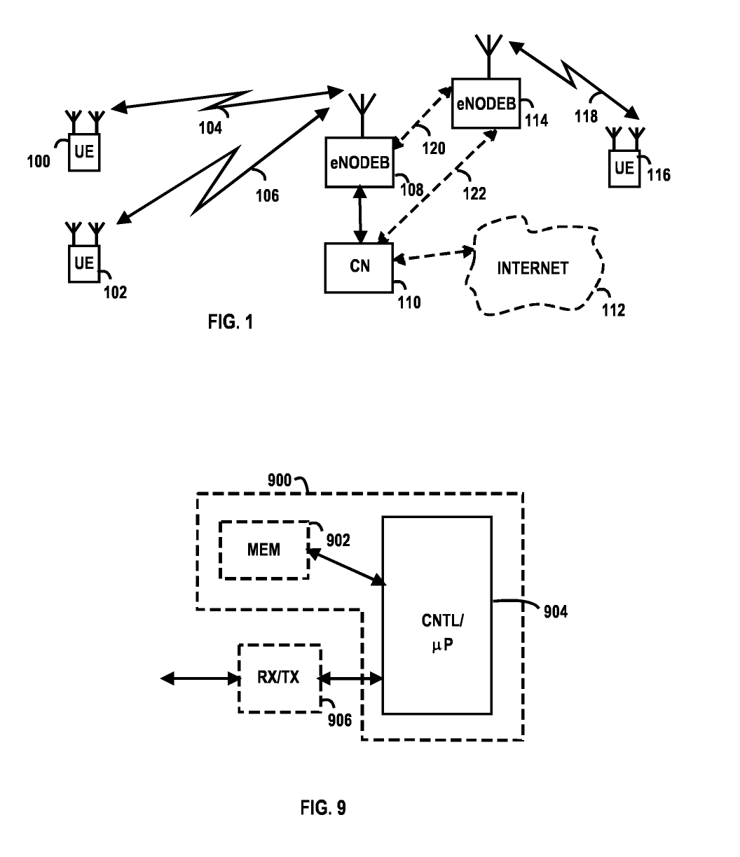

FIG. 1 is an example of a simplified system architecture only showing some elements and functional entities, all being logical units whose implementation may differ from what is shown. The connections shown in FIG. 1 are logical connections; the actual physical connections may be different. It is apparent to a person skilled in the art that the system typically comprises also other functions and structures than those shown in FIG. 1.

FIG. 1 shows a part of a radio access network of E-UTRA, LTE or LTE-Advanced (LTE-A) or LTE/SAE (SAE=system architecture evolution, SAE is enhancement of packet switched technology to cope with faster data rates and growth of Internet protocol traffic). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

The embodiments are not, however, restricted to the system given as an example but a person skilled in the art may apply the solution to other communication systems provided with the necessary properties. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), wideband code division multiple access (WCDMA), code division multiple access (CDMA), groupe special mobile or global system for mobile communications (GSM), enhanced data rates for GSM evolution (GSM EDGE or GERAN), systems using ultra-wideband (UwB) technology and different mesh networks. The embodiments are especially suitable for co-existence networks of two or more systems or layers of one or more systems. In the example of FIG. 1, a multilayer sharing of resources is expected and the system producing the layer capable to use a spectrum hole is depicted.

FIG. 1 shows user devices 100 and 102 configured to be in a wireless connection on one or more communication channels 104, 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to a base station, an access point or any other type of interfacing device including a relay station capable of operating in a wireless environment.

The (e)NodeB includes transceivers, for instance. From the transceivers of the (e)NodeB, a connection is provided to an antenna unit that establishes bi-directional radio links to user devices. The (e)NodeB is further connected to a core network 110 (CN). Depending on the system, the counterpart on the CN side can be a serving system architecture evolution (SAE) gateway (routing and forwarding user data packets), packet data network gateway (PDN GW), for providing connectivity to user devices (UEs) to external packet data networks, or mobile management entity (MME), etc.

The communication system is also able to communicate with other networks, such as a public switched telephone network or the Internet.

The user device illustrates one type of an apparatus to which resources on the air interface are allocated and assigned, and thus any feature described herein with a user device may be implemented with a corresponding apparatus. The user device may also be called a subscriber unit, mobile station, remote terminal, access terminal, user terminal or user equipment (UE) just to mention but a few names or apparatuses.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, laptop computer, game console, notebook, and multimedia device.

It should be understood that, in FIG. 1, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home (e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeB 108 of FIG. 1 may provide any kind of these cells. A cellular radio system may be implemented as a multilayer network including several kinds of cells. Typically, in multilayer networks, one node B provides one kind of a cell or cells, and thus a plurality of node Bs are required to provide such a network structure.

In FIG. 1, node (e)NodeB 114 may be a Home (e)Node or pico or femto node. It is operably coupled 120 to the (e)NodeB 108 which may provide a macro cell or a primary communication system cell. User device 116 depicts a user device communicating with the (e)NodeB via a radio link 118. The (e)NodeB may be coupled to the core network 110 directly 122 or indirectly via another network node. Recently for fulfilling the need for improving the deployment and performance of communication systems, concept of “plug-and-play” node (e)Bs has been introduced. Typically, a network which is able to use “plug-and-play” node (e)Bs, includes, in addition to Home node (e)Bs (Home (e)nodeBs), a home node B gateway, or HNB-GW (not shown in FIG. 1). A HNB Gateway (HNB-GW), which is typically installed within an operator's network aggregates traffic from a large number of HNBs back to a core network through Iu-cs and Iu-ps interfaces.

With increasing number of personal, local and wireless communication systems operating in a same geographical area, the questions of co-existence and inter-networking are raised. Cognitive and re-configurable radios may be a key for obtaining a heterogeneous communication environment where mitigation techniques and cognitive signalling are used for sharing the spectrum and routing information. Cognitive radios are designed to efficient spectrum use deploying so-called smart wireless devices being capable to sense and detect the environment and adapt to it thus being suitable for opportunistic spectrum usage, in which also the frequency bands not being used by their primary (usually licensed) users may be utilized by secondary users. For this purpose cognitive radios are designed to detect unused spectrum, such as spectrum holes.

The heterogeneous networks may also create new interference challenges due to the deployment of different wireless nodes such as macro/micro eNBs, pico eNBs, and Home eNBs creating a multi-layer network using the same spectrum resource.

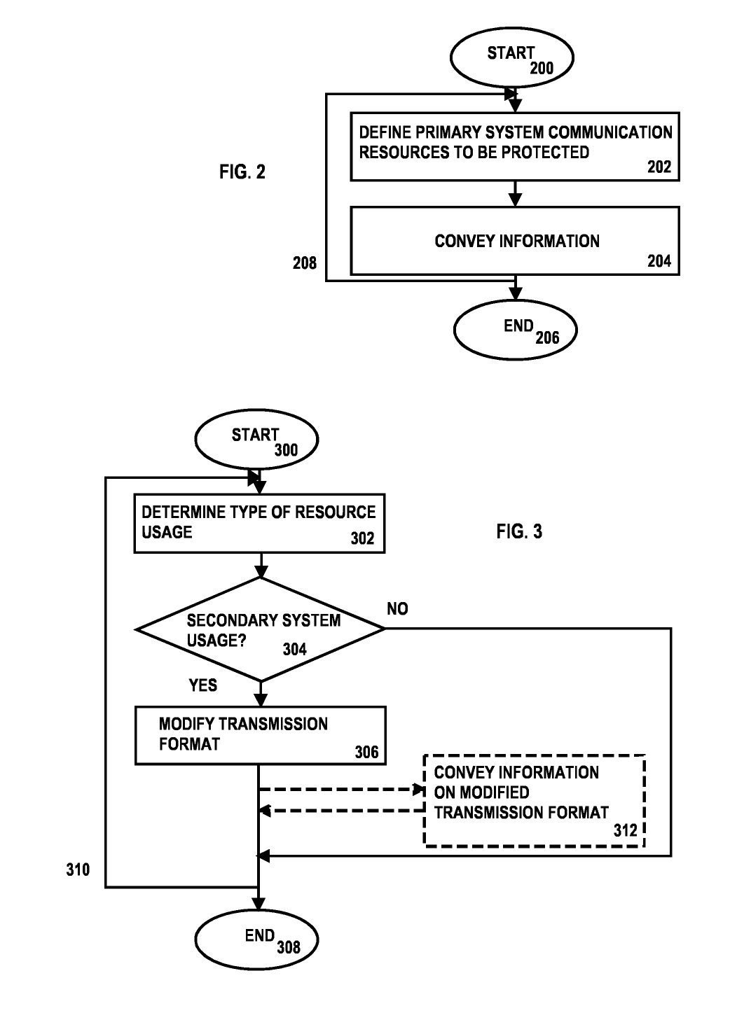

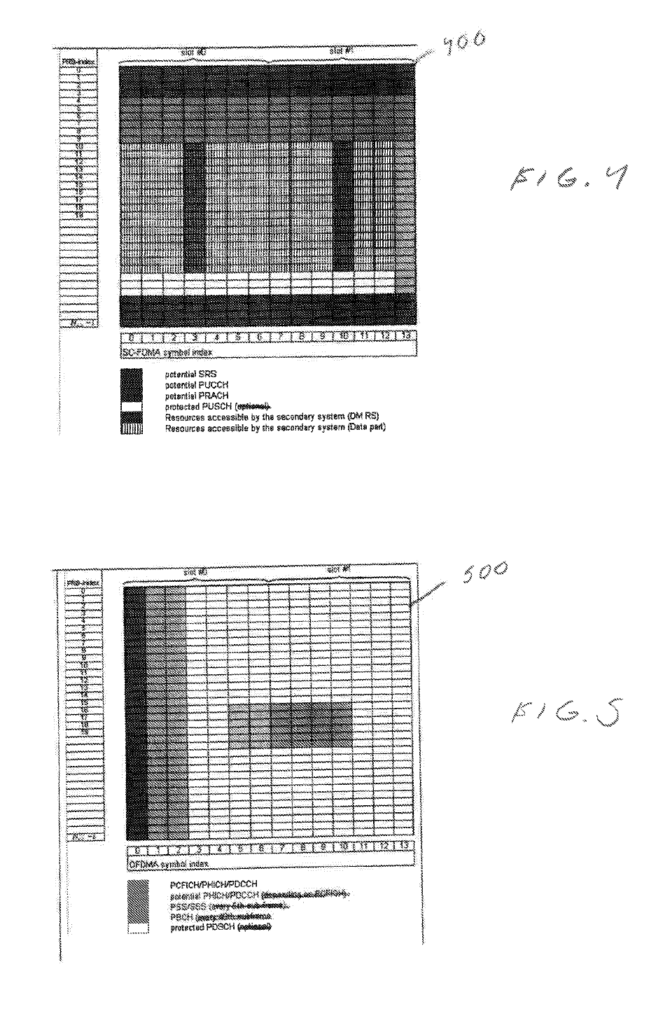

In the following, some embodiments of a method for enabling secondary spectrum use is explained in further detail by means of FIGS. 2 and 3. The embodiments are especially suitable for enabling system operation for a primary system when one or more secondary systems are allowed to operate on the same physical resources in the situation of co-existence/sharing of systems. Co-existence/spectrum sharing is one of major challenges in open spectrum usage.

Typically, in a geographical area, a system which is a licensed user has a primary user status and possible ad-hoc users or opportunistic users which are ready to use spectrum holes or corresponding resources are called secondary users. Secondary users are typically not allowed to cause too much interference to primary users.

The operability of a primary system is “preferential” in respect of a secondary system which means that the secondary system is not allowed to interfere too much the primary system. For example, a voice signal may be assumed to have a high priority and thus a system transferring the voice signal may have a primary system status. Protection of critical control signals of the primary system is an important issue. This protection may be carried out by using transmission and/or reception format modifications.

Embodiments provide control channel operation for a primary system in the presence of a secondary system.

One embodiment starts in block 200.

In block 202, primary system communication resources to be protected from a secondary system usage are defined.

Some examples of such resources are: allowed frequency resources, such as physical resources blocks (PRB), allowed time resources, such as sub-frames and/or symbols, time division duplex (TDD) configuration or corresponding information which relates to uplink and/or downlink usage of time division duplex resources, reference signal (RS) information, such as cell identification and/or transmission mode, and allowed power (or power spectral density) levels.

More precisely, resources may be divided into two groups: resources to be protected in the uplink and resources to be protected in the downlink.

In the following, a system based on the LTE is used as an unlimiting example.

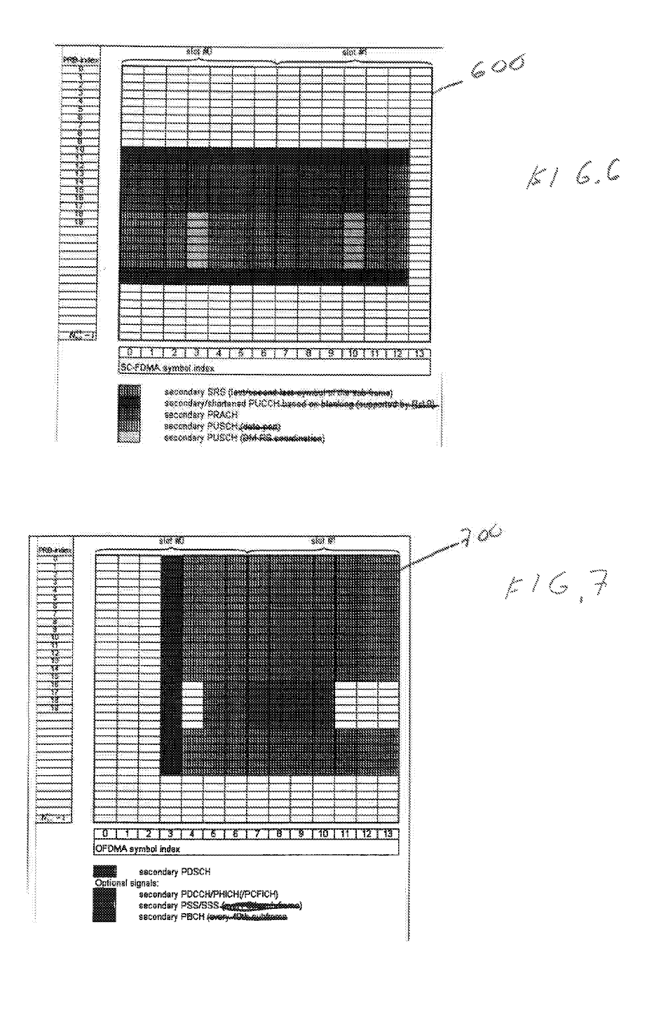

In the LTE, in the uplink, following primary system signals may be protected against a secondary system usage: resources (or number of PRBs) reserved for physical uplink control channel (PUCCH), cell-specific sounding reference signal (SRS) configuration (time and frequency), cell-specific physical random access channel (PRACH) configuration (time and frequency) and portions of physical uplink shared channel (PUSCH) resources (time and frequency) seen necessary. The example is further clarified by means of table 400 in FIG. 4. It should be understood that at least part of PUSCH is not protected.

In the LTE, in the downlink, following primary system signals (time and frequency) may be protected against a secondary system usage: physical control format indicator channel (PCFICH) indicating the time span that is the number of symbols reserved for physical downlink control channel (PDCCH) and/or PHICH (PHICH=physical HARQ (HARQ=hybrid automatic repeat request) indicator channel), and/or PDCCH, PHICH, primary synchronization signal (PSS), secondary synchronization signal (SSS) and/or physical broadcast channel (PBCH), portions of physical downlink shared channel (PDSCH) seen necessary, demodulation reference signal (DM RS). The example is further clarified by means table 500 in FIG. 5. In this example, PSS and/or SSS signals are to be protected in every 5^{th} sub-frame, and PBCH signals are to be protected in every 40^{th} sub-frame.

Resources to be protected may be identified based on information on primary cells, such as: a number of symbols reserved for PDCCH/PHICH (for example if less than 3), PSS/SSS/PBCH timing (information on frame and/or timeslot synchronisation), protected portion of PDSCH resources (frequency and/or time), information on downlink reference signals, such as a common reference signal (CRS), DM RS, and channel state information RS. The information may include transmission modes used and/or cell identification.

In block 204, information on the defined primary system communication resources to be protected is conveyed to network elements involved.

Information may be distributed to network elements or nodes via specific operation and maintenance interfaces, X2, over the air information (OTAC) or extending current broadcast control channel (BCCH) info. In a cognitive radio case, information required for resource sharing may be distributed to network nodes via a cognitive pilot channel (CPC). It should be appreciated that also other means may be used. It should be appreciated that it is also possible that resources to be protected may also be defined without any signaling between network elements. One example of this approach is that a standard defines the communication resources to be protected. Conveying may mean transmitting, initiating a transmission or generating a message to be transmitted, etc.

The embodiment ends in block 206. The embodiment is repeatable and one option for repetition is shown with arrow 208. Other options are naturally also possible.

In the following, another embodiment of a method for enabling secondary spectrum use is explained in further detail by means of FIG. 3. This embodiment describes one option for using the information on primary system communication resources to be protected from a secondary system usage.

The embodiment starts in block 300.

In block 302, a type of resource usage is determined, and if the type of resource usage is secondary system usage (block 304), at least one transmission (and/or reception) format is modified based on information on protection needs of primary system communication resources for protecting chosen primary system communication resources from the secondary system usage (block 306).

If the type of resource usage is primary system usage, the resources may be used in their “normal” formats that is to say unmodified formats. It should be appreciated that if transmission formats are modified, reception formats are usually modified correspondingly for enabling correct reception. Then the information on a modified transmission format may be conveyed typically for reception purposes (block 312). This may be carried out in such a manner that (e)NodeB signals user devices an indication of transmission format modifications regarding to a secondary system usage. The signaling may be carried out for instance via a broadcast channel, higher layer signaling or PDCCH.

The chosen primary system communication resources may be protected by muting the secondary system transmission on the corresponding resources.

Some examples of possible modifications are now explained by means of FIGS. 6 and 7. The system used for clarification purposes is the LTE, but it is obvious for a person skilled in the art that the principle is also applicable to other systems and coexistence of several systems.

FIGS. 6 and 7 show exemplary options to modify uplink and/or downlink transmission and/or reception formats to support secondary spectrum usage. The selected primary system communication resources are protected by muting the secondary system transmission on the corresponding resources. It should be noted that FIGS. 6 and 7 present a “worst case” sub-frame, worst case in the sense that all signals to be possibly protected are present in the sub-frame. In a typical situation, all different signals are not present in all sub-frames simultaneously. For example, SRS and PRACH usually occur only in part of sub-frames.

The concept of muting is used in the field of communication. Usually, when muted, the device does not transmit data (load signals, control signals and/or reference signals) at all or only by some limited amount via a muted resource for a period of time which is predetermined or negotiated. For the implementation of embodiments, the selection of a muting technique is not critical. Thus muting techniques are not explained herein in further detail.

Uplink modification examples are explained first by means of table 600 in FIG. 6. One possibility is to shorten by puncturing a last symbol out from a secondary uplink transmission. Some options for signals to be punctured are a data part of a secondary system PUSCH, secondary system PRACH and secondary system PUCCH. The two latter ones are not necessarily needed when a carrier aggregation operation is used. The secondary system PRACH may be punctured by diminishing cell ranges and limiting a cyclic prefix and guard period of a PRACH signal. The last symbol of secondary system PUCCH may be punctured out by puncturing one reference signal symbol and shifting data symbols accordingly, by using a shortened PUCCH format (already defined to avoid collision with SRS) or by puncturing one data symbol and modifying channel coding and PUCCH resource channelization, for instance for accommodating shortened orthogonal cover code length, accordingly.

Another possibility to shorten or narrow an uplink transmission is by transferring a signal to a different symbol or PRB on a secondary uplink transmission. Some options for signals to be transferred are a secondary system SRS (SRS symbol position is changed) which causes a need to puncture one or two last symbols out from a PUSCH, and a secondary system PUCCH (PRBs used by a secondary system PUCCH are not on the edges of a system bandwidth, but are moved towards the center of a carrier. This may be carried out by reserving excessive resources for a PUCCH format 2 on system bandwidth edges and leaving them unused as spare resources. This effectively moves used PUCCH resources towards the center of a carrier. This may also referred to as PUCCH blanking).

It is also possible to coordinate the usage of DM RS, SRS, and/or PRACH signals between the primary and secondary systems in such a manner that different RS sequence groups and/or PRACH signal preambles are used in the neighboring primary and secondary systems. Coordination of a secondary PUSCH signal and DM RS is also an option.

It should be understood that different combinations of the listed examples are also possible.

Downlink modification examples are now explained by means of table 700 in FIG. 7. Some options are: muting of a secondary system downlink PDSCH signal to minimize interference towards RS(s) of a primary cell and orthogonalization of reference signals (RS), such as a demodulation RS and/or channel state information RS. A standalone operation (carrier aggregation not used or not even available) requires also that a secondary system PDCCH, PHICH and/or PCFICH signal has to be located on a shifted position by the following manner: a secondary system PDSCH signal is shorten and/or secondary system PSS,SSS and/or PBCH transferred to a shifted position. Secondary system PSS and/or SSS signals may be transferred to a shifted position in every 5^{th} sub-frame and secondary system PBCH signals in every 40^{th} sub-frame.

It should be understood that different combinations of the listed examples are also possible.

A time division duplex (TDD) system with flexible and cell-specific TDD switching point configuration may be seen as a special case, wherein both uplink and downlink signals may be protected. A need to take this into account exists, when designing transmission formats for crossed slots (for slots having uncertainty with respect to a current TDD configuration). In this case, a secondary system cell does not know whether uplink and downlink slots are subjected to interference in neighbouring primary system cells. The principle is shown in FIG. 8 by means of table 800.

The embodiment ends in block 308. The embodiment is repeatable and one option for repetition is shown with arrow 310. Other options are naturally also possible.

It should be appreciated that reception formats typically correspond to transmission formats.

The steps/points, signaling messages and related functions described above in FIGS. 2 and 3 are in no absolute chronological order, and some of the steps/points may be performed simultaneously or in an order differing from the given one. Other functions can also be executed between the steps/points or within the steps/points and other signaling messages sent between the illustrated messages. Some of the steps/points or part of the steps/points can also be left out or replaced by a corresponding step/point or part of the step/point.

It should be understood that transmitting and/or receiving may herein mean preparing a transmission and/or reception, preparing a message to be transmitted and/or received, or physical transmission and/or reception itself, etc. on a case by case basis. In an embodiment, a server, node or host may convey information on the defined primary system communication resources to be protected to network elements involved by transmitting and in one other embodiment, it may receive that information. Additionally, conveying information may mean initiation of a message or a part of a message, or physical conveying, such as transmission, etc. depending on current application.

In the following an example of a system where embodiments may be applied to is explained in further detail by means of FIG. 1.

The system includes at least two nodes of which two are depicted. The node 114 is the one which is going to transmit as a secondary system using thus resources not used by a primary system. The node 108 provides a primary system or at least part of it. The primary system node 108 defines primary system communication resources to be protected from secondary system usage, and conveys information on the defined primary system communication resources to be protected to network elements involved, in this case to the secondary system node 114.

Then, after obtaining the information, the secondary system node 114 determines a type of resource usage and modifies transmission and/or reception formats based on information on protection needs of primary system communication resources for protecting chosen primary system communication resources from the secondary system usage, if the type of resource usage is secondary system usage.

It is also possible that another network element controls the usage of secondary resources in which case, this another network element controls the secondary system transmission. This procedure is possible for instance, when the node carrying out secondary system usage is a Home node or some other ad-hoc node. Then the controlling network element may be a node providing an upper layer cell, such a macro cell. In example of FIG. 1, the macro layer node may be the node 108 and a Home node or pico or femto node may be the node 114. Arrow 120 depicts how these nodes may be coupled to each other. The connection is typically a wireless link. Naturally, a primary system node and a secondary system node may communicate with each other. It is appreciated that a node may be a primary system node in one communication occasion and in another it may be a secondary system node and vice versa.

An embodiment provides an apparatus which may be any node device, host, server or any other suitable apparatus able to carry out processes described above in relation to FIGS. 2 and 3. It should be appreciated that especially in machine-to-machine or device-to-device communication also a user device may act as a node device and to be called as a node device when acting in this role. Further, it should be appreciated that especially in the case of a device-to-device communication between a plurality of user devices, one or more of the user devices may carry out processes described above in relation to FIGS. 2 and 3.

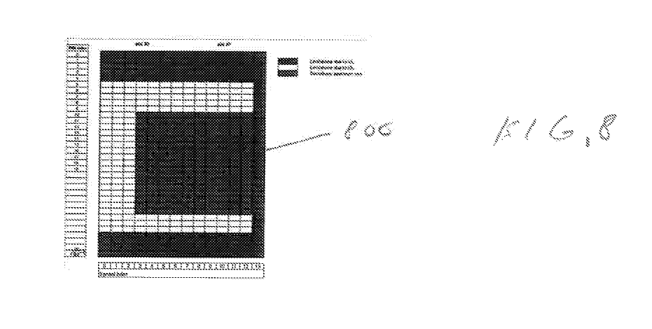

FIG. 9 illustrates a simplified block diagram of an apparatus according to an embodiment especially suitable for interference management. It should be appreciated that the apparatus may also include other units or parts than those depicted in FIG. 9. Although the apparatus has been depicted as one entity, different modules and memory (one or more) may be implemented in one or more physical or logical entities.

The apparatus 900 may in general include at least one processor, controller or a unit designed for carrying out control functions operably coupled to at least one memory unit and to various interfaces. Further, a memory unit may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus.

The apparatus may be a software application, or a module, or a unit configured as arithmetic operation, or as a program (including an added or updated software routine), executed by an operation processor. Programs, also called program products or computer programs, including software routines, applets and macros, can be stored in any apparatus-readable data storage medium and they include program instructions to perform particular tasks. Computer programs may be coded by a programming language, which may be a high-level programming language, such as objective-C, c, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, element, unit, etc., may be configured as a computer or a microprocessor, such as a single-chip computer element, or as a chipset, including at least a memory for providing storage capacity used for arithmetic operation and an operation processor for executing the arithmetic operation.

As an example of an apparatus according to an embodiment, it is shown an apparatus, such as a node device or network element, including facilities in a control unit 904 (including one or more processors, for example) to carry out functions of embodiments according to FIGS. 2 and 3. This is depicted in FIG. 9.

The apparatus may also include at least one processor 904 and at least one memory 902 including a computer program code, the at least one memory and the computer program code configured to, with the at least one processor, cause the apparatus at least to: define at least one primary system communication resource to be protected from secondary system usage, and convey information on the defined at least one primary system communication resource to be protected to network elements involved.

Another example of an apparatus comprises means 904 for defining at least one primary system communication resource to be protected from secondary system usage, and means 902, 904 for conveying information on the defined at least one primary system communication resource to be protected to network elements involved.

Yet another example of an apparatus comprises a definer configured to define at least one primary system communication resources to be protected from secondary system usage, and a conveying unit configured to convey information on the defined at least one primary system communication resource to be protected to network elements involved.

Yet another example of an apparatus includes at least one processor 904 and at least one memory 902 including a computer program code, the at least one memory and the computer program code configured to, with the at least one processor, cause the apparatus at least to: determine a type of resource usage and modify at least one transmission (and/or reception) format based on information on protection needs of primary system communication resources for protecting chosen at least one primary system communication resource from the secondary system usage, if the type of resource usage is secondary system usage.

Another example of an apparatus comprises means 904 for determining a type of resource usage and means 902, 904 for modifying at least one transmission (and/or reception) format based on information on protection needs of primary system communication resources for protecting chosen at least one primary system communication resource from the secondary system usage, if the type of resource usage is secondary system usage.

Yet another example of an apparatus comprises a determiner configured to determine a type of resource usage and a modifier configured to modify at least one transmission (and/or reception) format based on information on protection needs of primary system communication resources for protecting chosen at least one primary system communication resource from the secondary system usage, if the type of resource usage is secondary system usage.

Embodiments of FIGS. 2 and 3 may be carried out in processor or control unit 904 possibly with aid of memory 902 as well as a transmitter and/or receiver 906.

It should be appreciated that different units may be implemented as one module, unit, processor, etc., or as a combination of several modules, units, processor, etc.

It should be understood that the apparatuses may include other units or modules etc. used in or for transmission. However, they are irrelevant to the embodiments and therefore they need not to be discussed in more detail herein. Transmitting may herein mean transmitting via antennas to a radio path, carrying out preparations for physical transmissions or transmission control depending on the implementation, etc. The apparatus may utilize a transmitter and/or receiver which are not included in the apparatus itself, such as a processor, but are available to it, being operably coupled to the apparatus. This is depicted as an option in FIG. 9 as a transceiver 906. Embodiments provide computer programs embodied on a distribution medium, comprising program instructions which, when loaded into electronic apparatuses, constitute the apparatuses as explained above.

Other embodiments provide computer programs embodied on a computer readable medium, configured to control a processor to perform embodiments of the methods described above. The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described herein, or a combination thereof. For firmware or software, the implementation can be carried out through modules of at least one chip set (e.g., procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1-34. (canceled)

35. An apparatus comprising:
at least one processor and at least one memory including a computer program code, the at least one memory and the computer program code configured to, with the at least one processor, cause the apparatus at least to:
define at least one primary system communication resource to be protected from secondary system usage, and
convey information on the at least one defined primary system communication resource to be protected to network elements involved.

36. The apparatus of claim 35, wherein the at least one primary system does not need to control interference to the at least one secondary system, and the at least one secondary system has to control interference to the at least one primary system.

37. The apparatus of claim 35, wherein the at least one primary system communication resource to be protected is at least one of the following: frequency resources, time resources, time division duplex configuration, reference signal information, and power or power spectral density levels.

38. The apparatus of claim 35, wherein in the case of an uplink of the long term evolution system the at least one primary system communication resource to be protected is at least one of the following: at least one portion of physical resource blocks reserved for physical uplink control channel, cell-specific sounding reference signal resources, cell-specific physical random access channel resources and portions of physical uplink shared channel resources.

39. The apparatus of claim 35, wherein in the case of an downlink of the long term evolution system the at least one primary system communication resource to be protected is at least one of the following: physical downlink control channel, physical hybrid automatic repeat request indicator channel, primary synchronization signal, secondary synchronization signal, physical broadcast channel portions of physical downlink shared channel, demodulation reference signal.

40. The apparatus of claim 35, the apparatus comprising a server, host, node device or a user device.

41. A computer program comprising program instructions which, when loaded into the apparatus, constitute the modules of claim 35.

42. A method comprising:
defining at least one primary system communication resource to be protected from secondary system usage, and
conveying information on the at least one defined primary system communication resource to be protected to network elements involved.

43. The method of claim 42, wherein the at least one primary system does not need to control interference to the at least one secondary system, and the at least one secondary system has to control interference to the at least one primary system.

44. The method of claim 42, wherein the at least one primary system communication resource to be protected is at least one of the following: frequency resources, time resources, time division duplex configuration, reference signal information, and power or power spectral density levels.

45. The method of claim 42, wherein in the case of an uplink of the long term evolution system the at least one primary system communication resource to be protected is at least one of the following: at least one portion of physical resource blocks reserved for physical uplink control channel, cell-specific sounding reference signal resources, cell-specific physical random access channel resources and portions of physical uplink shared channel resources.

46. The method of claim 42, wherein in the case of an downlink of the long term evolution system the at least one primary system communication resource to be protected is at least one of the following: physical downlink control channel, physical hybrid automatic repeat request indicator channel, primary synchronization signal, secondary synchronization signal, physical broadcast channel portions of physical downlink shared channel, demodulation reference signal.

47. A computer program embodied on a computer-readable storage medium, the computer program comprising program code for controlling a process to execute a process, the process comprising:
defining at least one primary system communication resource to be protected from secondary system usage, and
conveying information on the at least one defined primary system communication resource to be protected to network elements involved.

48. The computer program of claim 47, wherein the at least one primary system communication resource to be protected is at least one of the following: frequency resources, time resources, time division duplex configuration, reference signal information, and power or power spectral density levels.

49. The computer program of claim 47, wherein in the case of an uplink of the long term evolution system the at least one primary system communication resource to be protected is at least one of the following: at least one portion of physical resource blocks reserved for physical uplink control channel, cell-specific sounding reference signal resources, cell-specific physical random access channel resources and portions of physical uplink shared channel resources.

50. The computer program of claim 47, wherein in the case of an downlink of the long term evolution system the at least one primary system communication resource to be protected is at least one of the following: physical downlink control channel, physical hybrid automatic repeat request indicator channel, primary synchronization signal, secondary synchronization signal, physical broadcast channel portions of physical downlink shared channel, demodulation reference signal.
